(19) United States
(12) Patent Application Publication
(10) Pub. No.: US 2007/0067620 A1
(43) Pub. Date: Mar. 22, 2007

(54) Systems and methods for third-party authentication

(75) Inventor: David Alexander Jevans, Los Altos, CA (US)

Correspondence Address: CARR & FERRELL LLP, 2200 GENG ROAD, PALO ALTO, CA, 94303, US

(73) Assignee: IronKey, Inc.

(21) Appl. No.: 11/517,129

(22) Filed: Sep. 6, 2006

Related U.S. Application Data
(60) Provisional application No. 60/714,200, filed on Sep. 6, 2005.

(51) Int. Cl. H04L 9/00

(52) U.S. Cl. 713/156

(57) ABSTRACT

A third-party authentication system can comprise a third-party digital device configured to receive an authentication signal to establish a secure link between a first-party device and a second-party network site, transmit a request to the first-party device for security information, the security information comprising a digital certificate, receive for security information, authenticate the digital certificate, and transmit an authentication file to the first-party device.

### CROSS-REFERENCE TO RELATED APPLICATIONS

This application claims benefit to U.S. provisional patent Ser. No. 60/714,200, filed Sep. 6, 2005, entitled “Authentication Key Registration and Authentication,” and U.S. nonprovisional application Ser. No. 11/486,799, filed Jul. 14, 2006, entitled “Secure Storage Device with Offline Code Entry” which claims the benefit of U.S. provisional patent Ser. No. 60/698,899, filed Jul. 14, 2005, entitled “Secure Storage Device with Offline Password Entry”, all of which are incorporated by reference herein.

### BACKGROUND

1. Field of the Invention

The present invention relates generally to authentication, and more particularly to third-party authentication.

2. Background Art

As the transmission of financial data, passwords, private information, and trade secrets become commonplace, the secure transmission of data across a network has become increasingly important. Many rely on secure socket layers within a browser, encrypted email, and/or virtual private networks (VPNs) to assist in the secure transmission of data. Unfortunately, these systems do not offer guarantees or proof of the identity of the sender of the information. Without safeguards, users run the risk of being impersonated online.

Digital certificates address this problem by providing an electronic means of verifying identify. Used in conjunction with encryption, digital certificates can help to provide additional confidence to the identities of parties involved in a transaction. Unfortunately, each commercial entity (e.g., bank, credit card company, email server, virtual private network) may require a separate digital certificate. As a result, even if the user acquires a digital certificate for one site, they often are required to acquire additional digital certificates for other sites operated by other commercial entities.

Further, each commercial entity must retrieve and authenticate the digital certificate before establishing a secure channel. This process requires that each commercial entity that wishes to establish a secure channel through the use of digital certificates possess electronic resources that can efficiently retrieve and authenticate digital certificates from users. This requires a considerable investment of time, funds, hardware, software, and expertise on the part of each commercial entity.

### SUMMARY OF THE INVENTION

An exemplary third-party authentication system can comprise a third-party digital device configured to receive an authentication signal to establish a secure link between a first-party device and a second-party network site, transmit a request to the first-party device for security information receive the security information, authenticate the digital certificate, and transmit an authentication file to the first-party device. The security information may comprise a digital certificate.

In various embodiments, the third-party authentication system further comprises a second-party server configured to receive the authentication file from the first-party device, verify the authentication file, and establish a secure link between the first-party device and the second-party network site.

The third-party digital device may be further configured to receive an other authentication signal from the first-party device to establish a secure link between the first-party device and a fourth-party network site, transmit an other request to the first-party device for the security information, receive the security information, authenticate the digital certificate, and transmit an other authentication file to the first-party device. The other authentication signal may indicate the first-party device network address.

The security information may further comprise a serial number of a USB device. The authentication signal can also indicate a second-party network site address and the authorization file can comprise a code based on the second-party network site address.

In various embodiments, the authentication signal is triggered by the first-party device by downloading a web page from the second-party network site or by the first-device party device interacting with the web page. The first-party device can comprise a USB storage device configured to store the digital certificate.

An exemplary third-party authentication method may comprise receiving an authentication signal at a third-party digital device to establish a secure link between a first-party device and a second-party network site, transmitting a request from the third-party digital device to the first-party device for security information, the security information comprising a digital certificate, receiving the security information, authenticating the digital certificate, and transmitting an authentication file from the third-party digital device to the first-party device.

A third-party authentication software product may comprise software operational when executed by a processor to receive an authentication signal at a third-party digital device to establish a secure link between a first-party device and a second-party network site, transmit a request from the third-party digital device to the first-party device for security information, the security information comprising a digital certificate, receive the security information, authenticate the digital certificate, and transmit an authentication file from the third-party digital device to the first-party device, and a storage medium configured to store the software product.

### BRIEF DESCRIPTION OF THE DRAWINGS

FIG. 1 illustrates a network for third-party authentication, in accordance with one embodiment.

FIG. 2 is a block diagram of the authentication server in one embodiment of the invention.

FIG. 3 is a flow chart for third-party authentication of security information, in accordance with one embodiment of the present invention.

FIG. 4 is a flowchart depicting the verification of the authentication file to establish the secure link between the second-party network site and a first-party device, in accordance with one embodiment of the present invention.

FIG. 5 is a block diagram of the authentication server in an exemplary implementation of the invention.

FIG. 6 depicts a secure storage device, in accordance with one embodiment of the present invention.

FIG. 7 is a block diagram of the secure storage device, in accordance with one embodiment of the present invention.

FIG. 8 is a flowchart for the provisioning of a digital certificate to a secure storage device, in accordance with one embodiment of the present invention.

FIG. 9 is a block diagram of the secure storage device, in accordance with one embodiment of the present invention.

### DETAILED DESCRIPTION

The embodiments discussed herein are illustrative of one example of the present invention. As these embodiments of the present invention are described with reference to illustrations, various modifications or adaptations of the methods and/or specific structures described may become apparent to those skilled in the art. All such modifications, adaptations, or variations that rely upon the teachings of the present invention, and through which these teachings have advanced the art, are considered to be within the scope of the present invention. Hence, these descriptions and drawings should not be considered in a limiting sense, as it is understood that the present invention is in no way limited to only the embodiments illustrated.

In order to establish secure communication and file transfer between two or more digital devices, a secure link can be created. A digital device is any device with a processor capable of sending or receiving data (e.g., a computer, laptop, personal digital assistant, server, cell phone). A secure link is a communications channel in which network data is encrypted or otherwise safe from unauthorized use, access, interception, monitoring, or the like. Some examples of secure links with a web site include, but are not limited to, secure socket layers (SSL), secure hypertext transport protocol (SHTTP) and transport-layer security (TLS). Network data may include, but is not limited to data, files, and messages that may be transmitted and/or received over a network.

A third-party authentication system can be used to authenticate a first-party device prior to establishing a secure link between the first-party device and a second-party network site. In one example, a user device requests to establish a secure link with a bank website. An authentication signal may be transmitted to a third-party server, such as an authentication server, to perform authentication services. The third-party server may retrieve and authenticate security information (e.g., a digital certificate) from the user device. If the authentication is successful, the third-party server may download an authentication file (e.g., cookie) to the user device or the bank website. The bank website may then verify the authentication file and establish the secure link between the user device and the bank website based on the authentication.

A first-party device, second-party network site, and a third-party digital device are digital devices owned and/or operated by a different entity. Examples of entities include, but are not limited to any person, organization, or company. In one example, a first-party device may be operated by a banking client, the second-party network site may be a website operated by the bank, and the third-party digital device may be operated by a company that provides authentication services.

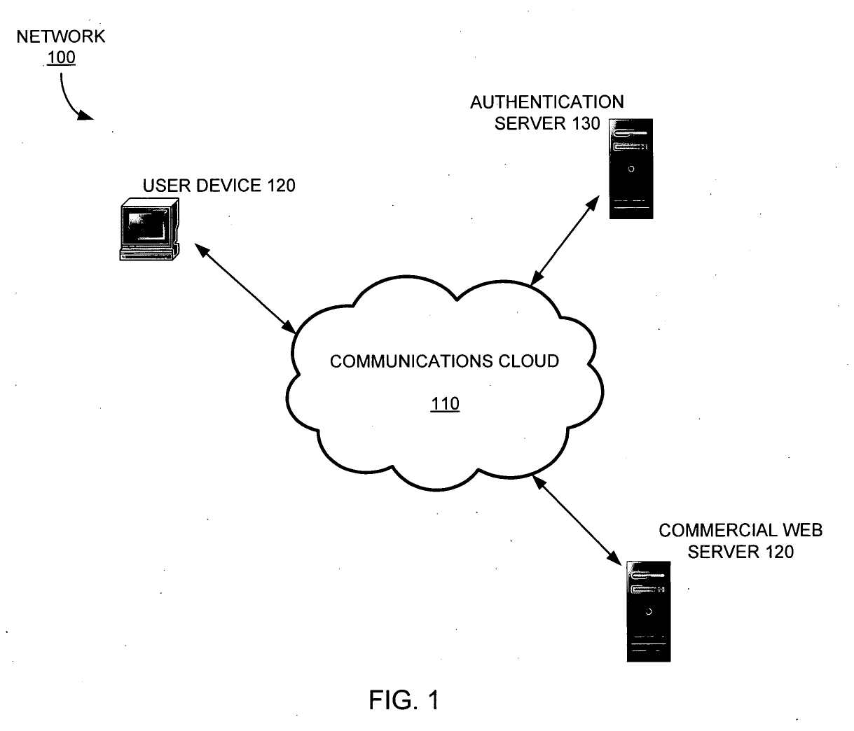

FIG. 1 illustrates a network 100 for third-party authentication, in accordance with one embodiment. A user device 120, an authentication server 130, and a commercial web server 140 are each coupled to a communications cloud 110. The user device 120, the authentication server 130, and the commercial web server 140 may each comprise a digital device.

The communications cloud 110 couples the digital devices together to allow the digital devices to communicate and transmit network data to each other. The communications cloud 110 may be a single device or multiple devices. In one embodiment, the communications cloud 110 is a router that routes data to a limited number of digital devices. In another embodiment, the communications cloud 110 comprises multiple routers, bridges, and hubs that couple a large number of digital devices. A communications cloud 110 may also be another network, such as the Internet, that allows digital devices to communicate and transmit data to each other.

Depending upon the topology of the network 100, the communications cloud 110 is optional. For example, the network 100 may connect the digital devices with a ring topology. In a ring topology, each digital device may communicate directly to one or two digital devices on the network 100 without the requirement of a communications cloud 110.

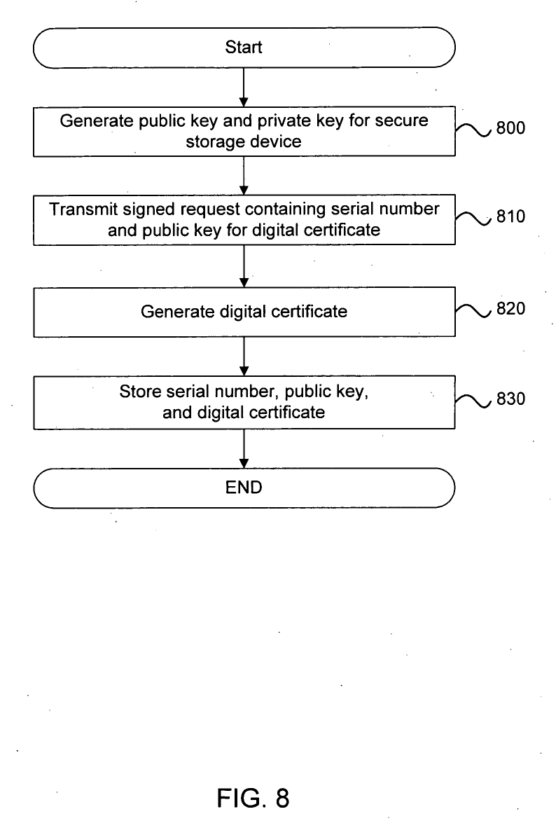

The user device 120 is any digital device configured to access and store secure data on the network 100. In some examples, the user device 120 can access bank information, store personal information, transmit credit card numbers, or electronically transfer funds. To perform these tasks the user device 120 may acquire one or more digital certificates to establish one or more secure links. The digital certificate can comprise the user devices' public key, user devices' name, an expiration date of the public key, the name of the issuer that issued the digital certificate (further discussed in FIG. 8), the digital certificate serial number, and/or the digital signature of the issuer.

In one example, the user device 120 is issued a digital certificate and the digital certificate is stored on the user device 120. In some embodiments, the authentication server 130 issues the digital certificate. In alternate embodiments, the authentication server 130 may be associated with the issuer of the digital certificate. The user device 120 can access data from the commercial web server 140 over the communications cloud 110.

The authentication server 130 is any server configured to provide authentication services to allow the commercial web server 140 to establish a secure link with the user device 120. In exemplary embodiments, the authentication server 130 retrieves the digital certificate from the user device 120. The digital certificate is then authenticated to determine if the digital certificate is authentic.

In one example, the digital certificate is unencrypted and parsed to determine if the user device 120 is authorized to enter into a secure link with the commercial web server 140. If the digital certificate is authorized, the authentication server 130 may transmit an authentication file (e.g., a cookie) to the user device 120 which subsequently stores the authentication file.

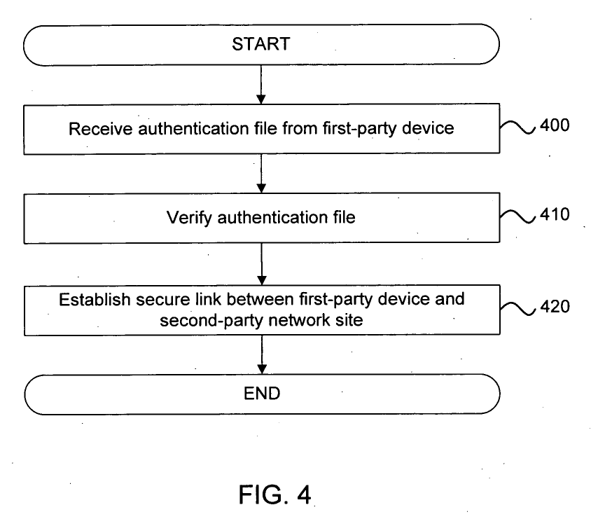

When the user device 120 seeks to establish the secure link with the commercial web server 140, the commercial web server 140 may rely upon the authentication services performed by the authentication server 130 and verify the authentication file. In one example, the commercial web server 140 may receive a request by the user device 120 to login or establish a secure connection. The commercial web server 140 may then retrieve and verify the authentication file (verification of the authentication file is further discussed in FIG. 4.)

In various embodiments, the authentication server 130 comprises issuer information about the digital certificate provided by the issuer of the digital certificate. The issuer information may include, but is not limited to, the issuer's public key, issuer's serial number, issuer's expiration date of the digital certificate, issuer's digital signature, and/or any other information related to the issuer and the digital certificate. In some embodiments, the authentication server 130 decrypts the digital certificate using either the owner's public key or the issuer's public key. A hash function may then be performed on all or a part of the digital certificate to ensure that the integrity of the digital certificate has not been altered. Subsequently, the contents of the digital certificate can then be compared to-the issuer information to authenticate the digital certificate. Those skilled in the art will recognize that there may be many methods with which a digital signature may be authenticated.

The commercial web server 140 is any digital device configured to provide access and store data over the network 100. In exemplary embodiments, the commercial web server 140 hosts web pages and establishes secure links between itself and verified user devices 140. In one example, the commercial web server 140 verifies the authentication file on the user device 120 to determine if the secure link can be formed.

Although the commercial web server 140 is depicted in FIG. 1 as being a single server, the commercial web server 140 may be any number of digital devices configured to provide and receive data within the network 100.

Similarly, although the commercial web server 140 is identified as a web server, the commercial web server 140 may be any digital device configured to receive and provide information to one or more other digital devices over the network 100. In one example commercial web server 140 may be a database or other data structure configured to provide data to one or more user devices 140. There may be any number commercial web servers 120.

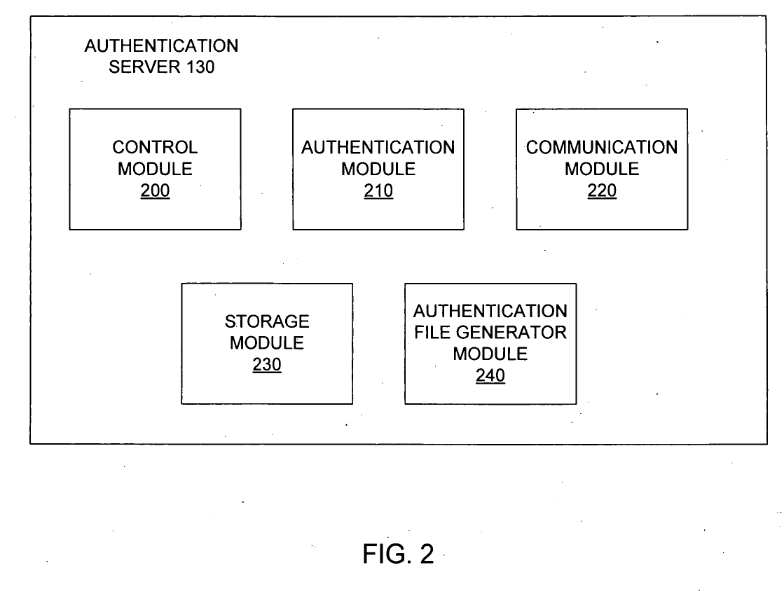

FIG. 2 is a block diagram of the authentication server 130 (FIG. 1) in one embodiment of the invention. The authentication server 130 comprises a control module 200, an authentication module 210, a communication module 220, an authentication file generator module 240, and a storage module 230.

The control module 200 controls the authentication server 130. In some embodiments, the control module 200 can control a processor or circuitry within the authentication server 130.

The authentication module 210 is configured to receive and authenticate the security information (e.g., a digital certificate). In one example, the control module 200 retrieves the digital certificate from the user device 120 (FIG. 1) through the communication module 220 (further described herein.) Subsequently, the control module 200 transmits the security information to the authentication module 210. The authentication module 210 can then authenticate the digital certificate.

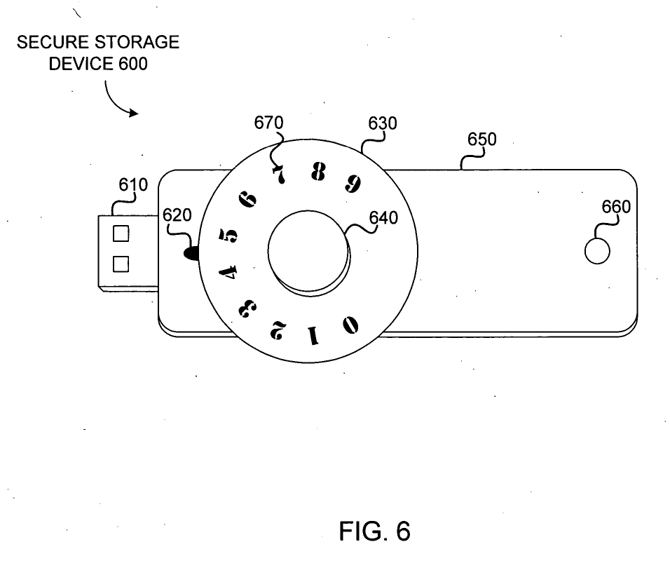

In some embodiments, the authentication module 210 decrypts all or some of the digital certificate and then determines if the integrity of the digital certificate has been altered. The control module 200 can provide issuer information from the storage module 230 to the authentication module 210 to compare all or some of the information within the digital certificate to that of the issuer of the digital certificate. Issuer information can include, but is not limited to, the owner's public key, the owner's private key, the owner's name, the serial number of a secure storage device that stores the authentication identification (further discussed in FIG. 6), a serial number of a digital device that stores the security information, a digital signature, an expiration date of the public key, the issuer's name, the issuer's public key, or any other information related to the authentication of the digital certificate.

The communication module 220 is configured to receive and transmit network data related to the security information or the authentication file. In one example, the control module 200 may direct the communication module 220 to receive the security information. Subsequently, if the security information is successfully authenticated by the authentication module 210, then the control module 200 may direct the communication module 220.to transmit an authentication file (e.g., cookie) from the authentication file generator module 240 to the user device 120 or the commercial web server 140 (FIG. 1).

If the authentication module 210 successfully authenticates the digital certificate, the control module 200 may direct the authentication file generator module 240 to generate an authentication file. The authentication file is any file that indicates that the security information was authenticated. In one example, the authentication file comprises a user identifier and a user code. The user identifier is any name or number that identifies the user and/or the user device 120. The user code is any serial number, code, key, or password that may be recognized by the commercial web server 140 as an indication that the security information was authenticated.

In some embodiments, the authentication file generator module 240 identifies the commercial web server 140 with which the user device 120 may wish to establish a secure link. The authentication file generator module 240 retrieves a user code from the storage module 230 that may be recognized by the commercial web server 140. In one example, the authentication file generator module 240 determines the commercial web server 140 from the authentication signal. Once the commercial web server 140 is identified, the authentication file generator module 240 may retrieve one or more user codes (or instructions regarding user codes) that may be recognized by the commercial web server 140 from the storage module 230. The authentication file generator module 240 may then generate the appropriate authentication file. In some embodiments, the authentication file is digitally signed and may be subsequently authenticated by the commercial web server 140.

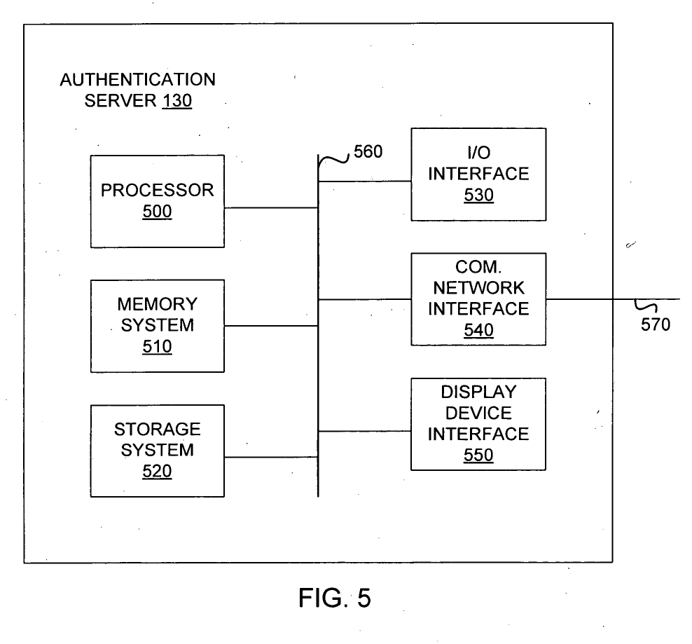

The storage module 230 can comprise one more databases or other data structures of stored data. The storage module 230 may be contained within a storage system. The storage system is further discussed in FIG. 5. The stored data may comprise issuer information as well as user codes, commercial web server 140 identifiers, instructions regarding user codes that may be recognized by one or more commercial web servers 120, and statistics regarding the digital certificates. Such statistics may include the number of times that security information has been authenticated, any failures to authenticate the security information, the history of security information received from one or more user devices 120, or any other information regarding the function of the authentication server 130.

In exemplary embodiments, the authentication module 210 may utilize the statistics to accept or reject authentication of security information. In one example, the same user device 120 may have offered several digital certificates that failed to be authenticated. As a result, the authentication module 210 may determine to reject authentication of any security information from the particular user device 120. Black lists comprising user devices 120 that will not be authenticated may be stored within the storage module 230.

The control module 200, the authentication module 210, the communication module 220, the authentication file generator module 240, and the storage module 230 may individually be software modules or implemented in hardware. Software modules comprise executable code that may be processed by a processor (not depicted).

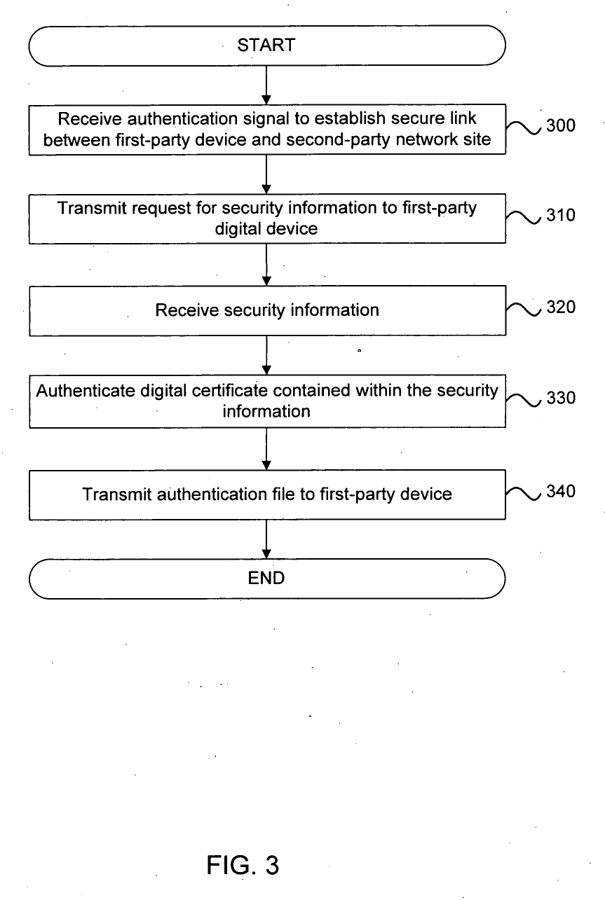

FIG. 3 is a flow chart for third-party authentication of security information, in accordance with one embodiment of the present invention. In exemplary embodiments, the first-party device (e.g., a user device 120 (FIG. 1)) accesses a webpage hosted by the second-party network site (e.g., commercial web server 140 (FIG. 1) such as a bank.) As the webpage is downloaded to the user device 120, an image or pixel may be retrieved from the authentication server 130 (FIG. 1) (e.g., through a domain name server (DNS) hosted by the commercial web server 140.) The image or pixel downloaded from the authentication server 130 to the user device 120 may comprise an authentication signal and/or a request to authenticate security information on the user device 120, if available, in order to allow the commercial web server 140 to automatically establish a secure link with the user device 120 without requiring the time, hardware, software, expertise, and/or expense of authenticating the security information.

In some embodiments, the image retrieved from the authentication server 130 may be different for each user and/or second-party network site as a form of anti-phishing. The user of the first-party device can verify the second-party network site's authenticity by confirming the image. In one example, the authentication server 130 authenticates the digital certificate on the first-party device. Subsequently, a particular image is transmitted to a web page displayed by the first-party device. The user of the first-party device can then confirm the image and verify that the second-party network site is authentic. In some embodiments, the particular image may be selected by the authentication server 130 based on the first-party device, the second-party network site and/or the digital certificate. In other embodiments, the user selects the image to be transmitted.

The communication module 220 (FIG. 2) of the authentication server 130 receives the authentication signal to establish a secure link between the first-party device and the second-party network site in step 300. In one example, the first-party device is a user device 120 and the second-party network site is a corporate network server. The user device 120 and/or the corporate network server transmit the authentication signal to the communication module 220 of the authentication server.

In step 310, the control module 200 (FIG. 2) controls the communication module 220 to pull security information from the first-party device. In one example, the communication module 220 retrieves the digital certificate from the user device 120. In other embodiments, the control module 200 controls the communication module 220 to transmit a request for security information to the user device 120 which may subsequently provide the security information.

In step 320, the communication module 220 receives the security information from the user device 120 and provides the security information to the authentication module 210 (FIG.2). In step 330, the authentication module 210 authenticates the digital certificate contained within the security information.

In some embodiments, the security information does not contain a digital certificate. In one example, the authentication module 210 can authenticate security information through the use of java scripts or activeX controls. Those skilled in the art will appreciate that there may be many methods to authenticate security information.

If the security information is authenticated by the authentication module 210, then the control module 200 directs the authentication file generator module 240 (FIG. 2) to generate an authentication file. The control module 200 may then direct the communication module 220 to provide the authentication file to the first-party device in step 340.

FIG. 4 is a flowchart depicting the-verification of the authentication file to establish the secure link between the second-party network site and a first-party device in accordance with one embodiment of the present invention. In step 400, the second-party network site may receive the authentication file from the first-party device. In alternative embodiments, the second-party network site may otherwise access the authentication file.

The second-party network site subsequently verifies the authentication file in step 410. In one example, the second-party network site maintains a database of user identifiers (e.g., usernames, passwords) and previously stored user codes. The second-party network site may access the authentication file and retrieve the user code. The user code from the authentication file and-the username and/or password provided by the first-party device on the second-party network site may then be compared to the database of user identifiers and user codes to verify the authentication file. If the authentication file is verified, the second-party network site may establish a secure link with the first-party device in step 420.

If the authentication file is not present or not verified, then the second-party network site may provide an offer to the first-party device to apply for a digital certificate or provide the user of the first-party device with an opportunity to automatically establish a secure link.

In various embodiments, the first-party device must initially request that a secure link with the second-party network site be automatically generated. In one example, the first-party device is offered the opportunity to request that a secure link be established upon logging onto the second-party network site. If the first-party device requests to establish the secure link once or upon logging onto the second-party network site, the first-party device may activate the authentication signal by interacting with the second-party network site (e.g., clicking on a button, link, or image on the website.) The security information contained within the first-party device is then authenticated as described in FIG. 3.

FIG. 5 is a block diagram of the authentication server 130 (FIG. 1) in an exemplary implementation of the invention. The authentication server 130 comprises a processor 500, a memory system 510, a storage system 520, an input/output (“I/O”) interface 530, a communication network interface 540, and a display interface 550 which are all coupled to a system bus 560. The processor 500 is configured to execute executable instructions. In some embodiments, the processor 500 comprises circuitry or any processor capable of processing the executable instructions.

The memory system 510 is any memory configured to store data. Some examples of the memory system 510 are storage devices, such as RAM or ROM. The storage system 520 is any storage configured to retrieve and store data. Some examples of the storage system 520 are flash drives, hard drives, optical drives, and/or magnetic tape. The storage system 520 can comprise a database or other data structure configured to hold and organize data. In some embodiments, the authentication server 130 includes the memory system 510 in the form of RAM and the storage system 520 in the form of flash data.

The I/O interface 530 is any device that can receive input from the one or more user devices 120 (FIG. 1) and one or more commercial web servers 140 (FIG. 1). The I/O interface 530 can couple to a keyboard, touchscreen, mouse, keypad, printer, scanner, or any other input or output device.

The communication network interface 540 can be coupled to the communications cloud 110 (FIG. 1) via the link 570. Moreover, the communication network interface 540 may support communication over many kind of connections, including, but not limited to, a USB connection, a firewire connection, an Ethernet connection, a serial connection, a parallel connection, an ATA connection. The communication network interface 540 may also support wireless communication (e.g., 802.11 a/b/g/n or wireless USB). It will be apparent to those skilled in the art that the communication network interface 540 can support many wired and wireless standards.

The display interface 550 is any device that can control a display device. A display device can be a monitor, screen, LCD, flatscreen, or any device configured to display information.

The above-described functions can be comprised of instructions that are stored on a storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

Referring to FIG. 6, a secure storage device 600 is depicted which may be used to store the digital certificate in accordance with an embodiment of the present invention. In exemplary embodiments, security information may be stored within the secure storage device 600. The user device 120 (FIG. 1) (e.g., first-party device) may comprise a digital device coupled to the secure storage device 600. In one example, when the user device 120 downloads the login page from the commercial web server 120 or logs in, the authentication server 130 checks to see if the digital certificate is stored within the secure storage device 600 and/or if the stored secure storage device 600 is present. If the secure storage device 600 is present but does not include a digital certificate, an offer to acquire a digital certificate may be transmitted to the first-party device. If the secure storage device 600 is not present, then a message indicating that the secure storage device 600 is not available may be transmitted to the user device.

Although the secure storage device 600 is discussed herein, the digital certificate may be stored in any memory or storage. Some examples of internal storage for storing the digital certificate include, but are not limited to, a hard drive, RAM, flash memory, or any other kind of storage or memory. In some embodiments, the digital certificate is stored externally from the user's digital device.

Some examples of external storage for storing the digital certificate include, but are not limited to, a USB device, external harddrive, CD, DVD, and/or flash drive. The external storage may be physically coupled to the user's digital device or coupled via a wireless connection (e.g., Bluetooth, WiFi, WiMax, etc.) A USB device may be any USB device configured to store or receive information over a USB connection with a digital device. In some examples, the digital certificate may be stored on another server or digital device and may be accessed via the user's digital device.

The secure storage device 600 comprises a USB connector 610 coupled to a secure storage device housing 650. A user can turn a user input knob 640 to turn a radial digital input 630 to enter the user code into the secure storage device 600. A code indicator 620 marks a code character 670 to be entered into the secure storage device 600 as a part of the user code. An authorization indicator 660 indicates when the user code has been accepted and access to the stored data on the secure storage device 600 has been authorized.

In one example, a user carries stored data within the secure storage device 600. Prior to plugging the secure storage device 600 into a USB port of a user device 120 (FIG. 1) (e.g., a digital device), the user enters the user code into the secure storage device 600 by turning the user input knob 640 to turn the radial dial input 630 so that one or more code characters 670 are lined up with the code indicator 620. After the correct user code has been entered, the authorization indicator 660 can illuminate or otherwise indicate that access to the stored data has been authorized. The user may then proceed to plug the secure storage device 600 into the user device 120 to access the stored data.

If the user fails to enter the correct user code but plugs the secure storage device 600 into the user device, the user device may fail to recognize the secure storage device 600, fail to mount the digital media within the secure storage device 600, fail to execute the device driver for the secure storage device 600, and/or be unable to access the stored data.

In various embodiments, the user can turn the turn the user input knob 640 to align the code character 670 on the radial dial input 630 with the code indicator 620 and the enter the code character 670 into the secure storage device 600. In one example, the user depresses the user input knob 640 to enter the code character 670 aligned with the code indicator 620. In another example, the user depresses a button (not depicted) to enter the code character 670 into the user code. In some embodiments, there is a switch or button that locks the secure storage device 600 to prevent the user from inputting a user code or code character 670 unintentionally (e.g., while the user is carrying the secure storage device 600 in a pocket).

The USB connector 610 can be coupled to any USB port of the user device 120. Although a USB connector 610 is depicted in FIG. 6, the secure storage device 600 is not limited to a USB type connector. In some embodiments, the secure storage device 600 can be coupled to the user device through a firewire port, Ethernet connector, serial port, parallel port, SCSI port, or ATA connector. Further, the secure storage device 600 can operationally couple wirelessly to the user device over 802.66 a/b/g/n standards, Bluetooth, or wireless USB. It is apparent to those skilled in the art that the secure storage device 600 can be operationally coupled to the user device in many ways.

In various embodiments, the secure storage device 600 can be physically or wirelessly coupled to the user device but the connection is not operational until the user code is entered into the secure storage device 600. In one example, the secure storage device 600 comprises the USB connector 610 coupled to the user device. Until the user code is entered into the secure storage device 600, the user device may not recognize the secure storage device 600, load the device driver for the secure storage device 600, or mount the media contained within the secure storage device 600.

The storage device housing 650 may contain any type of data storage medium or storage system as well as a power source. The data storage medium (not depicted) may comprise flash memory (e.g., NAND flash or NOR flash memory), a hard drive, ram disk, or any other kind of data storage. A storage system (further described in FIG. 8) can comprise the data storage medium. The power source (not depicted) can be a rechargeable battery, a replaceable battery (e.g., AA), or a capacitor. In some embodiments, the battery or capacitor can be recharged by the user device through the USB connector 610 (or any connector that couples the secure storage device 600 to the user device).

Similarly, although the user code input is facilitated by the radial dial input 630, the user input knob 640, and the code indicator 620 in FIG. 6, it is apparent to those skilled in the art that the user code can be input into the secure storage device 600 in many ways. In one example, the secure storage device 600 comprises a keypad with which the user can press keys to enter the user code. In another example, the secure storage device 600 comprises a biometric sensor which can receive the voice, fingerprint, or retina scan of the user as the user code.

The authorization indicator 660 displays an indicator when the user code has been accepted and that access to the stored data is authorized. The authorization indicator 660 can comprise a light emitting diode (LED) that emits a light to indicate that the user code has been accepted. In some embodiments, the authorization indicator 660 can generate a light of a first color to indicate user code acceptance (e.g., green) and a second color to indicate that the user code has been rejected (e.g., red). The authorization indicator 660 may comprise multiple LEDs to indicate user code acceptance, rejection, or lockout of the secure storage device 600.

A lockout occurs when the secure storage device 600 no longer allows the user to gain access to data stored within the secure storage device 600. An authorization lockout may be triggered if one or more incorrect user codes are received. An authorization lockout locks the secure storage device 600 so that the secure storage device 600 will refuse to accept any user codes until reset. In other embodiments, a sound may be generated by the secure storage device 600 to indicate that the user code has been accepted or rejected.

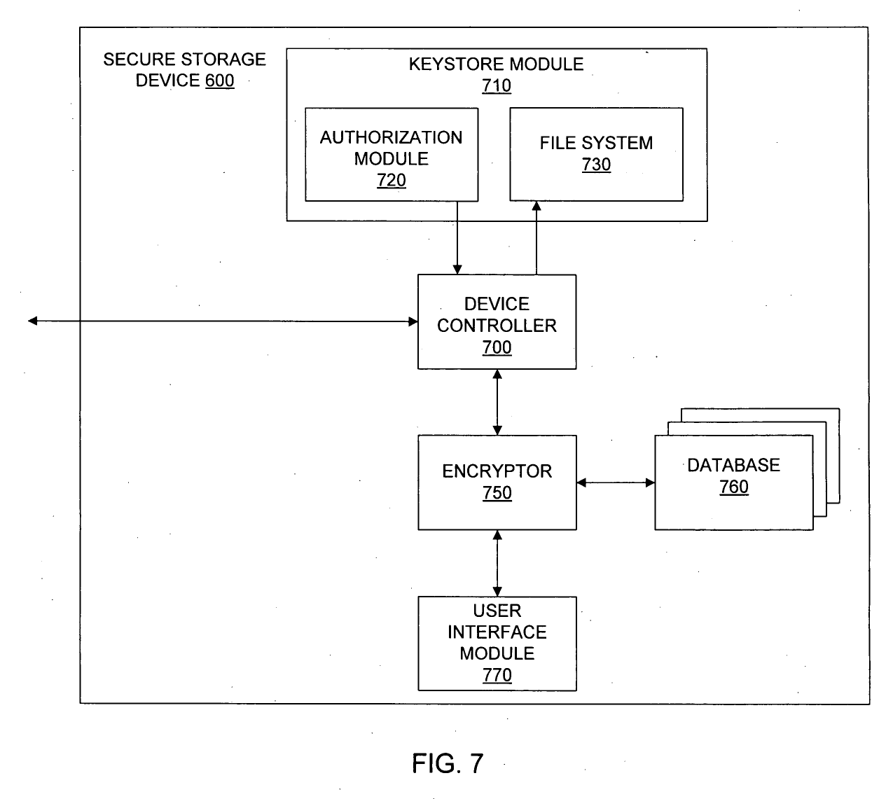

FIG. 7 is a block diagram of the secure storage device 600, in accordance with one embodiment of the present invention. The secure storage device 600 comprises a device controller 700 coupled to the keystore module 710. The keystore module 710 comprises an authorization module 720 and a file system 730. The device controller 700 is further coupled to an encryptor 750 which is further coupled to database 760 and a user interface module 770.

The device controller 700 can comprise the device driver for the secure storage device 600. The device controller 700 controls the communication with the digital device (not depicted) as well as the operations within the secure storage device 600. In some embodiments, the device controller 700 can control a processor or circuitry within the secure storage device 600.

In various embodiments, the device controller 700 receives an identification query from a user device requesting the type of device of the secure storage device 600. If authorized, the device controller 700 can respond by transmitting a signal to the user device identifying the secure storage device 600 and allowing any digital media to be mounted within the operating system of the user device. If not authorized, the device controller 700 may refuse to respond or reject the user device's attempts to mount the digital media.

In other embodiments, the device controller 700 receives the identification query from the user device and identifies the secure storage device 600 as a compact disc (CD). The user device may then attempt to automatically run an authorization check program from the device controller 700. This feature is similar to automatically playing the first song on an audio CD upon loading of the CD. The authorization check program can determine if access to the stored data is authorized. If access to stored data is not authorized, the authorization check program may terminate or the transmission of data between the user device and the secure storage device 600 may terminate. Further, the device controller 700 may refuse to allow the user device access to the database 760 and/or refuse to allow the digital media to be mounted.

The device controller 700 may also control the authorization indicator 660 (FIG. 6) based on an authorization indicator signal from the authorization module 720. In one example, if access to the stored data is authorized, the device controller 700 may send a signal to the authorization indicator 160 to illuminate an LED or generate a sound to indicate that access to the stored data is authorized. The device controller 700 can also generate a signal to the authorization indicator 660 to illuminate an LED or generate a sound to indicate that authorization is denied or that the secure storage device 600 is locked.

The keystore module 710 authorizes access to the stored data within the database 760. The keystore module 710 comprises the authorization module 720 and optionally a file system 730. In some embodiments, the keystore module 710 also comprises one or more authentication passwords to authorize access to the stored data. In other embodiments, the one or more authentication passwords are within the file system 730. An authentication password is a password, code, or key retained the secure storage device 600 to authenticate the user code.

The authorization module 720 receives the user code or a security code (discussed herein) and determines if the user is authorized to access the stored data. In exemplary embodiments, the authorization module 720 determines if the user is authorized to access the stored data based on the user code (or the security code) and the one or more authentication passwords. In one example, the authorization module 720 decrypts an authentication password with user code (or security code). If the decrypted authentication password is correct, then the user may be authorized to access the stored data. If the user is authorized to access the stored data, the authorization module 720 may transmit an authorization signal to the device controller 700 to authorize access. If the user is not authorized, the authorization module 720 may refuse to respond to subsequent attempts to access the data (e.g., locking the secured storage device 600).

In some embodiments, the secure storage device 600 does not comprise authentication passwords. As a result, the authorization module 720 can base the authorization determination on the user code. Those skilled in the art will appreciate that there may be many methods in which the authorization module 720 determine authorization to access the stored data based, at least in part, on the user code or security code.

The file system 730 can maintain a list of one or more authentication passwords and/or the file system of the database 760. In various embodiments, the file system 730 can associate each authentication password with a different partition within the digital media. As a result, separate user codes may access different partitions within the digital media. In one example, a first user code entered by a user may authorize access to a partition with data used at the user's home. A second user code may authorize access to a partition with business data. As a result, a single secure storage device 600 may be shared with co-workers or others which may be allowed to access some, but not all, of the stored data retained within the secure storage device 600. In other embodiments, the file system 730 can maintain a list of one or more user codes associated with the different partitions within the digital media.

Further, in some embodiments, the file system 730 maintains the scrambled database file system of the database 760. The database file system is a map of the stored data retained within the database 760. Without the database file system, the user device may not be able to identify stored data contained within the database 760. By separating the database file system from the database 760, a thief who removes the database 760 from the secure storage device 600 may fail to steal the database file system. Further, the database file system may be scrambled. The authorization module 720 can unscramble the database file system within the file system 730 or the database 760 when access to the stored data is authorized.

The encryptor 750 functions to encrypt or decrypt security codes, stored data within the database 760, or the file system 730. In exemplary embodiments, the stored data within the database 760 is encrypted. If access to stored data is authorized, the encryptor 750 encrypts data transmitted from the user device prior to storage within the database 760. Further, as stored data is requested from the database 760, the encryptor 750 can decrypt the stored data prior to transmission of the stored data to the user device. As a result, the stored data within the database 760 may always be encrypted.

The encryptor 750 can also decrypt the security code using the user code prior to authorization. When the security code is decrypted, the security code may be sent to the authorization module 720 where it may be compared to the one or more authentication passwords within the keystore module 710. In some embodiments, the database 760 and the keystore module 710 are retained on separate chips within the secure storage device 600.

The database 760 can comprise one more databases or other data structures of stored data. The database 760 may be contained within a storage system. The storage system is further discussed in FIG. 8. In exemplary embodiments, the digital certificate, public encryption keys for authorizing a secure link, and/or the private encryption keys for authorizing a secure link, may be stored within the database 760.

The user interface module 770 controls the user interface (e.g., the radial dial input 630 in FIG. 6) and receives the user code. In exemplary embodiments, the user interface module 770 receives the user code from the user. In some embodiments, the user interface module 770 sends the user code to the encryptor 750 to decrypt the user code. In other embodiments, the user interface module 770 sends the user code to the encryptor 750 to decrypt a security code. The security code may be used to authorize access to the stored data.

The device controller 700, keystore module 710, authorization module 720, encryptor 750, user interface module 770, and database 760 may individually be software module or implemented in hardware. Software modules comprise executable code that may be processed by a processor (not depicted).

FIG. 8 is a flowchart for the provisioning of a digital certificate to a secure storage device 600 (FIG. 6) in accordance with one embodiment of the present invention. In step 800, a security server (not depicted) automatically generates a public key and private key for a secure storage device 600. The private key is a private encryption key and the public key is a public encryption key. In some embodiment, the security server generates a private key which is then used to generate a public key. The private key and public key may be stored within the database 760 (FIG. 7) and/or the encryptor 750 (FIG. 7) within the secure storage device 600.

In step 810, a signed request containing a serial number for the secure storage device 600 and the public key is transmitted to an authorization server (not depicted) to receive a digital certificate. A signed request is a secure request signed by a digital signature and/or comprising a public key, serial number, and/or any information that may be used to authenticate the request. The authorization server is a certification authority (CA) that is configured to generate digital certificates. In some embodiments, the device controller 700 (FIG. 7) or other module of the secure storage device 600 transmits the signed request. In other embodiments, the security server transmits the signed request to the authorization server.

In step 820, the authorization server generates the digital certificate. In one example, the authorization server verifies the requester's credentials and uses the embedded public key within the signed request to authenticate the attached digital signature and validate the digital certificate. With validation the authorization server can issue the digital certificate upon which the digital certificate is transmitted to the secure storage device 600. Those skilled in the art will appreciate that many methods may be used to authenticate the signed request and/or the digital signature prior to issuing the digital certificate.

In step 830, the serial number, public key, and the digital certificate is stored within the authorization module 720 (FIG. 7), the encryptor 750, and/or the database 760 of the secure storage device 600. In some embodiments, the digital certificate is stored while the serial number, public key, private key, and/or digital signature may be stored during a separate step.

Although FIG. 8 discusses the provisioning of a secure storage device 600, this method can be used to provide a digital certificate to any storage device including, but not limited to, flash storage, hard drives, external USB storage devices, cellular telephones, NAND memory, or any device or medium capable of storing network data.

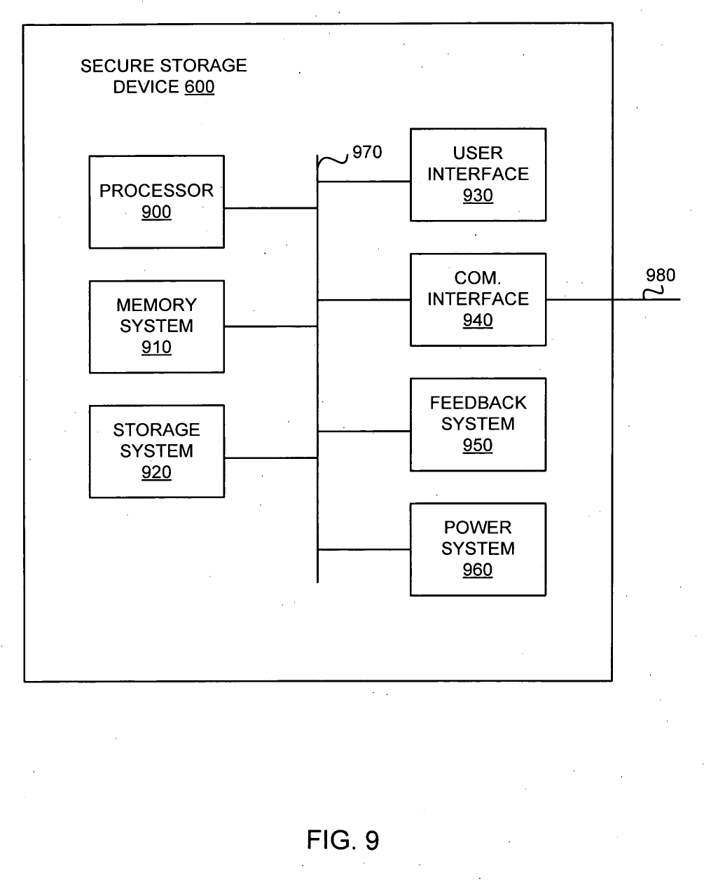

FIG. 9 is a block diagram of the secure storage device 600 (FIG. 6), in accordance with one embodiment of the present invention. The secure storage device 600 comprises a processor 900, an optional memory system 910, a storage system 920, a user interface 930, a communication interface 940, feedback system 950, and a power system 960 which are all coupled to a system bus 970. The processor 900 is configured to execute executable instructions. In some embodiments, the processor 900 comprises circuitry or any one or more processors capable of processing the executable instructions.

The memory system 910 is any memory configured to store data. Some examples of the memory system 920 are storage devices, such as RAM or ROM.

The storage system 920 is any storage configured to retrieve and store data. Some examples of the storage system 920 are flash drives, hard drives, optical drives, and/or magnetic tape. The storage system 920 can comprise a database 760 (FIG. 7) or other data structure configured to hold and organize data. In some embodiments, the secure storage device 600 includes memory 820 in the form of RAM and storage 840 in the form of flash data.

The user interface 930 is any device that can receive a user code. The user interface 930 can be, but is not limited to, a radial dial, keypad, or biosensor.

The communication interface 940 can be coupled to any user device via the link 980. As discussed in FIG. 6, the communication interface 940 may support communication over a USB connection, a firewire connection, an Ethernet connection, a serial connection, a parallel connection, or an ATA connection. The communication interface 940 may also support wireless communication (e.g., 802.11 a/b/g/n or wireless USB). It will be apparent to those skilled in the art that the communication interface 940 can support many wired and wireless standards.

The feedback system 950 is any indicator that signals the user that access to the stored data within the secure storage device 600 is authorized. In some examples, the feedback system 950 can be an LED light or sound. The feedback system 950 may also indicate that access to the stored data is not authorized or that the secure storage device 600 is locked.

The optional power system 960 is any system that can provide power to the secure storage device. The power system 960 can supply power to the secure storage device 600 to receive the user code and authorize access to the stored data. In one example, the power system 960 comprises a rechargeable battery, a replaceable battery, or a capacitor. The batteries or capacitor may be recharged with a power recharger or from power received from the user device. In some embodiments, the power system 960 is optional, and the user code can be passively received. Once the secure storage device 600 is coupled to the user device, power can be received from the user device and the authorization process completed.

In some embodiments, the power system 960 supplies power to the processor 900 when the secure storage device 600 is not coupled to a user device. In one example, the power system 960 supplies power to the processor 900 during the process of receiving the user code and authorization. Once the secure storage device 600 is coupled to the user device, the user device may supply power to the secure storage device.

The above-described functions can be comprised of executable instructions that are stored on storage media. The executable instructions can be retrieved and executed by the processor 900. Some examples of executable instructions are software, program code, and firmware. Some examples of storage media are memory devices, tape, disks, integrated circuits, and servers. The executable instructions are operational when executed by the processor to direct the processor to operate in accord with the invention. Those skilled in the art are familiar with executable instructions, processor(s), and storage media.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

What is claimed is:

1. A third-party authentication system comprising:
a third-party digital device configured to
receive an authentication signal to establish a secure link between a first-party device and a second-party network site;
transmit a request to the first-party device for security information, the security information comprising a digital certificate;
receive the security information;
authenticate the digital certificate; and
transmit an authentication file to the first-party device.

2. The system of claim 1, wherein the first-party device comprises a USB storage device configured to store the digital certificate.

3. The system of claim 1, further comprising a second-party server configured to receive the authentication file from the first-party device, verify the authentication file, and establish a secure link between the first-party device and the second-party network site.

4. The system of claim 1, wherein the security information further comprises a serial number of a USB device.

5. The system of claim 1, wherein the authentication signal further indicates a second-party network site address.

6. The system of claim 5, wherein the authorization file comprises a code based on the second-party network site address.

7. The system of claim 1, wherein the authentication signal is triggered by the first-party device downloading a web page from the second-party network site.

8. The system of claim 1, wherein the authentication signal is triggered in response to the first-party device interacting with a web page from the second-party network site.

9. The system of claim 1, wherein the third-party digital device is further configured to
receive an other authentication signal from the first-party device to establish a secure link between the first-party device and a fourth-party network site;
transmit an other request to the first-party device for the security information, the security information comprising the digital certificate;
receive the security information;
authenticate the digital certificate; and
transmit an other authentication file to the first-party device.

10. A third-party authentication method comprising:
receiving an authentication signal at a third-party digital device to establish a secure link between a first-party device and a second-party network site;
transmitting a request from the third-party digital device to the first-party device for security information, the security information comprising a digital certificate;
receiving the security information;
authenticating the digital certificate; and
transmitting an authentication file from the third-party digital device to the first-party device.

11. The method of claim 10, wherein the first-party device comprises a USB storage device configured to store the digital certificate.

12. The method of claim 10, further comprising receiving the authentication file from the first-party device, verifying the authentication file, and establishing a secure link between the first-party device and the second-party network site.

13. The method of claim 10, wherein the security information further comprises a serial number of a USB device.

14. The method of claim 10, wherein the authentication signal further indicates a second-party network site address.

15. The method of claim 14, wherein the authorization file comprises a code based on the second-party network site address.

16. The method of claim 10, further comprising triggering the authentication signal based on the first-party device downloading a web page from the second-party network site.

17. The method of claim 10, further comprising triggering the authentication signal based on the first-party device interacting with a web page from the second-party network site.

18. The method of claim 10, further comprising:
receiving an other authentication signal from a fourth-party network site to establish a secure link between the first-party device and the fourth-party network site;
transmitting an other request from the third-party digital device to the first-party device for the security information, the security information comprising a digital certificate;
receiving the security information;
authenticating the digital certificate; and
transmitting an other authentication file from the third-party digital device to the first-party device.

19. A third-party authentication software product comprising:
software operational when executed by a processor to
receive an authentication signal at a third-party digital device to establish a secure link between a first-party device and a second-party network site;
transmit a request from the third-party digital device to the first-party device for security information, the security information comprising a digital certificate;
receive the security information;
authenticate the digital certificate; and
transmit an authentication file from the third-party digital device to the first-party device; and
a storage medium configured to store the software product.

20. The software product of claim 19, wherein the first-party device comprises a USB storage device configured to store the digital certificate.

21. The software product of claim 19, wherein the software is further operational when executed by the processor to receive the authentication file from the first-party device, verify the authentication file, and establish a secure link between the first-party device and the second-party network site.

22. The software product of claim 19, wherein the security information further comprises a serial number of a USB device.

23. The software product of claim 19, wherein the authentication signal further indicates a second-party network site address.

24. The software product of claim 23, wherein the authorization file comprises a code based on the second-party network site address.

25. The software product of claim 19, wherein the authentication signal is triggered by the first-party device downloading a web page from the second-party network site.

26. The software product of claim 19, wherein the authentication signal is triggered in response to the first-party device interacting with a web page from the second-party network site.

27. The software product of claim 19, wherein the software is further operational when executed by the processor to receive an other authentication signal from a fourth-party network site to establish a secure link between the first-party device and the fourth-party network site, transmit an other request from the third-party digital device to the first-party device for the security information, the security information comprising the digital certificate, receive the security information, authenticate the digital certificate, and transmit an other authentication file from the third-party digital device to the first-party device.
